(19) United States
(12) Patent Application Publication
(10) Pub. No.: US 2002/0058159 A1
(43) Pub. Date: May 16, 2002

(54) Soft magnetic underlayer (SUL) for perpendicular recording medium

(76) Inventors: Yukiko Kubota, Pittsburgh, PA (US); Dieter Weller, Gibsonia, PA (US); Mei-Ling Wu, Cranberry Township, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/003,363

(22) Filed: Nov. 15, 2001

Related U.S. Application Data
(60) Provisional application No. 60/249,080, filed on Nov. 15, 2000.
(60) Provisional application No. 60/257,003, filed on Dec. 20, 2000.

(51) Int. Cl. G11B 5/66

(52) U.S. Cl. 428/694 TM

(57) ABSTRACT

A soft magnetic underlayer for a perpendicular recording medium includes a iron-cobalt alloy as the soft magnetic underlayer. In a preferred embodiment the iron-cobalt alloy is also alloyed with boron. The magnetic underlayer is radially textured such that the magnetic recording material has a magnetically easy axis in the radial direction and a magnetically hard axis in the circumferential direction.

### BACKGROUND OF THE INVENTION

This application is based on Provisional Patent Applications Serial No. 60/249,080 filed on Nov. 15, 2000, and Serial No. 60/257,003 filed on Dec. 20, 2000.

### FIELD OF THE INVENTION

The present invention generally relates to magnetic recording media such as for a computer disc drive, and more particularly to a soft magnetic underlayer for a perpendicular recording medium and a method of making the same.

### BACKGROUND OF THE INVENTION

In conventional magnetic recording, an electrical signal applied to a recording transducer is converted into a magnetic signal stored on a magnetic tape or disc recording medium. In the case of a computer disc, for example, the so-called perpendicular magnetization mode has an advantage over the longitudinal mode. In the former, the signal is recorded by magnetizing the magnetic recording medium material in the film normal direction, whereas the latter magnetizes the medium material in parallel to the film plane. Magnetic recording media for use in perpendicular recording have a magnetic layer with a direction of easy magnetization axis perpendicular to the surface of the recording layer, that is, in the direction of thickness thereof.

Magnetic materials with highly uniaxial or perpendicular anisotropy such as Cobalt-Chromium (CoCr) based alloys, Cobalt-Palladium (Co/Pd) and Cobalt-Platinum (Co/Pt) type multilayers, Barium-ferrites (Ba-ferrites) and Llₒ-ordered phases have been proposed as the perpendicular recording layer either with or without a soft magnetic keeper layer, or soft magnetic underlayer (SUL), underneath the recording layer. One role of the SUL is to focus the magnetic flux from the write head into the recording layer. This enables higher writing resolution in the double layered perpendicular media with SUL, compared to that in single layer perpendicular media without a soft magnetic underlayer. SUL material must be magnetically soft with very low coercivity (less than a few Oersteds), and have high permeability. The saturation magnetization of the SUL needs to be large enough so than that the flux saturation from the write head can be entirely absorbed without saturating the SUL. Based on these requirements, a numbers of soft magnetic materials may be suitable as SUL, e.g. as permalloy, Cobalt-Zicroium-Niobium (CoZrNb), and Iron-Aluminum-Nitrogen (FeAlN).

One of the key problems in dual-layer perpendicular recording media is the occurrence of noise due to the presence of the soft magnetic underlayer (SUL) during read-out of the recorded bit information. SUL related noise is generally confounded with other media noise sources, e.g. transition noise, and cannot easily be distinguished from them. However, there are specific signatures of SUL-noise that have been identified. One of them is so-called “spike-noise”, which is attributed to the presence of magnetic domains in the SUL. Spike-noise occurs at specific frequencies compatible with the characteristic lateral dimensions of the magnetic domains in the SUL. Another SUL specific noise source is “ripple noise”. This SUL noise has its origin in long wavelength (micron scale) modulations of the magnetization, which are due to local dispersions of the anisotropy axes in the soft material. Avoidance of magnetic domains and micromagnetic ripple structures in SUL materials is one of the critical requirements to achieving low noise perpendicular media. To avoid these micromagnetic structures, the SUL essentially needs to be brought into a single domain magnetic state.

Several alternatives have been proposed to achieve this single domain state:

(1) Applying an external field inside the disk drive, e.g. generated by hard magnets. This approach would require architectural changes to the disk drive to solve the SUL noise problem rather then solving the noise problem within the media themselves.

(2) Exchange coupling of the SUL to a hard magnetic layer, which is magnetically oriented, i.e. in a single domain state. In this proposed scheme a CoSm or a similar hard magnetic pinning layer generated first. The easy magnetic axis can be oriented in the disk radial (cross track direction) and the subsequently deposited soft magnetic material (e.g. CoZrNb) aligns with the pinning layer due to direct ferromagnetic exchange interactions.

(3) Exchange coupling of the SUL to an Antiferromagnet. This approach relies on antiferromagnetic interactions rather than ferromagnetic interactions to pin the SUL in the radial direction. The antiferromagnet, e.g. IrMn is again oriented in the radial direction by applying a field during film growth, e.g. sputtering.

Other proposals seek to generate nanocrystalline SULs with grain sizes compatible or smaller than those in the recording media themselves. Such an approach would not eliminate SUL noise altogether, but it would suppress SUL noise to acceptable levels compatible with whatever noise sources prevail in the granular recording layer itself. This particular approach has been pursued by Hitachi (nanocrystalline FeTaC SUL) and Toshiba (nanocrystalline layered Fe/C SUL). Lamination or layering in their work was used to generate the nanocrystalline microstructure necessary to contain noise.

In the present invention, we pursue a new and much more efficient alternative to generate single domain SULs capable of completely eliminating SUL noise. Our invention is distinctly different from approaches 2 and 3 in that the radial single domain state is generated via an internal anisotropy mechanism, rather than relying on interfaces.

It has been discovered by the inventors that the iron-cobalt (FeCo) based high saturation magnetization materials can be fabricated with the magnetic easy axis aligned in the radial direction in the disc substrate without the processing and/or structural complexities described above. Addition of glass forming materials such as boron (B), and carbon (C) maintains the SUL layer in amorphous or nano-crystalline state to provide extremely smooth surface and high magnetization, which are also the basic requirements for making had disc drive medium.

Therefore the present invention provides a magnetically soft underlayer between the initial substrate and the magnetic recording material to enhance the properties of the magnetic recording material, such as by reducing the noise generated by the soft magnetic underlayer.

The present invention further provides a method of manufacturing a laminated soft magnetic underlayer for a perpendicular recording medium.

The present invention still further provides a method of producing a magnetic recording medium which reduces or eliminates the need for post-processing activities.

### SUMMARY OF THE INVENTION

The above and other objects, features and advantages of the present inventions are attained by a magnetic recording medium which comprises a substrate, a non-magnetic spacer material on the substrate, and a soft magnetic underlayer on the non-magnetic spacer material, the soft magnetic underlayer containing iron, cobalt and boron.

A method of manufacturing a perpendicular magnetic recording medium comprised of providing a substrate, depositing a non-magnetic spacer material on the substrate, depositing a soft magnetic underlayer containing iron, cobalt and boron on the non-magnetic spacer material, and depositing a perpendicular magnetic recording material on the soft magnetic underlayer. A second non-magnetic spacer material is deposited on the soft magnetic underlayer prior to the deposition of the magnetic recording material. The soft magnetic underlayer may also be a laminated structure.

The present invention provides a means of suppressing the SUL noise by inducing magnetic anisotropy in the plane of the film, and also provides the layer structure and its fabrication process. The magnetic easy axis of the SUL lies in the radial direction of a disc substrate, and therefore, the hard axis lies in the circumferential direction. An anisotropy field of 40˜50 Oersteds (Oe) or higher is desired. The SUL material is a high magnetization amorphous and/or amorphous-nanocrystalline composite material such as a FeCoB alloy.

### BRIEF DESCRIPTION OF THE DRAWINGS

Various other objects, feature and advantages of the invention will become more apparent by reading the following detailed description in conjunction with the drawings, which are shown by way of example only, wherein:

FIG. 1A is a schematic representation of a computer disc indicating the radial and circumferential directions thereon;

FIG. 1B presents the cross-sectional view of a double layer perpendicular medium;

FIG. 2 consisting of FIGS. 2A and 2B, are schematic representations shown in cross-section, of a magnetic recording medium manufactured according to the present invention;

FIG. 3 presents the remanent magnetization comparison between the radial and circumferential directions as a function of amorphous Iron-Cobalt-Boron (FeCoB) layer thickness, for structure shown in FIG. 2A;

FIG. 4 is an example of process flow diagram, showing the incorporation of the present invention into conventional disc manufacturing process; and

FIG. 5 is a graphical representation of an in-plane MOKE diagram for the magnetic recording medium manufactured according to the teachings of the present invention.

### DESCRIPTION OF THE PREFERRED EMBODIMENTS

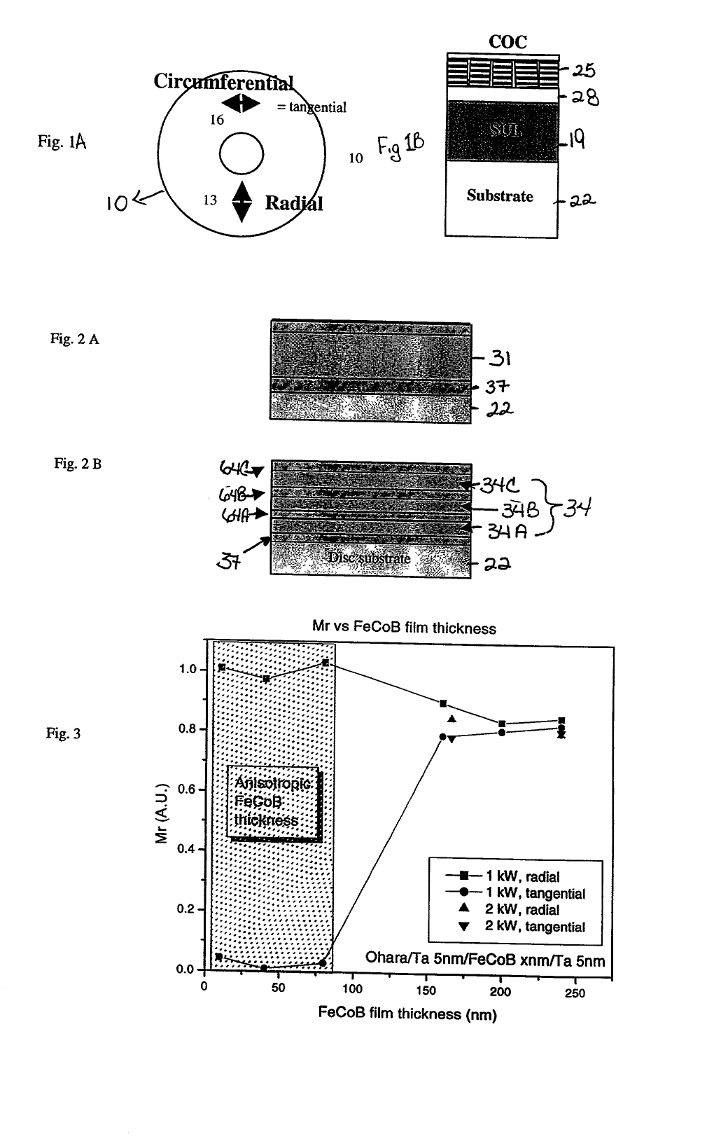

Referring now to the drawings in detail, FIG. 1A shows a schematic representation of a conventional recording medium, such as computer disc 10 indicating thereon the radial 13 and circumferential 16 directions. FIG. 1B shows a cross-sectional view of a typical recording medium 10 incorporating a soft magnetic underlayer (SUL) 19 of the present invention. The disc 10 generally comprises a substrate 22 upon which is deposited the various materials to construct the magnetic recording medium 10. As shown in the cross-sectional representation of FIG. 1B the magnetic underlayer 19 is disposed between the substrate 22 and a recording layer 25. An interlayer 28 may be deposited between the SUL 19 and the recording layer 25. According to the present invention, the soft magnetic underlayer 19 can be comprised of either a single relatively thick layer 31 (FIG. 2A) or a laminated structure 34 (FIG. 2B). In either case the magnetic underlayer 19 is radially textured in that the finished magnetic recording material layer 19 has a magnetically easy axis in the radial direction 13 and a magnetically hard axis in the circumferential direction 16. Experimentation has shown that it is preferable to provide a laminated soft magnetic underlayer 34 (FIG. 2B) which results in an improved signal to noise ratio for the recording material layer 25.

The substrate 22 can be any conventional substrate well known in the art such as a glass material or an aluminum or aluminum magnesium alloy. For example, the substrate 22 may be an glass-ceramics composite substrate of between 31.5 and 50 mil thickness. Preferably prior to depositing the soft magnetic underlayer 19, an adhesion layer 37 is provided on the substrate 22. This adhesion layer 37 may comprise a tantalum (Ta) layer having a thickness of about 1-5 nm. After this adhesion layer 37 has been deposited, the soft magnetic underlayer 19 is deposited thereon.

As it is well known in the art, the process used to deposit the layers for manufacture of the magnetic recording medium is preferably by means of sputter deposition. This manufacturing process is well known to those skilled in the art, and most preferably is provided by a DC magnetron sputtering technique.

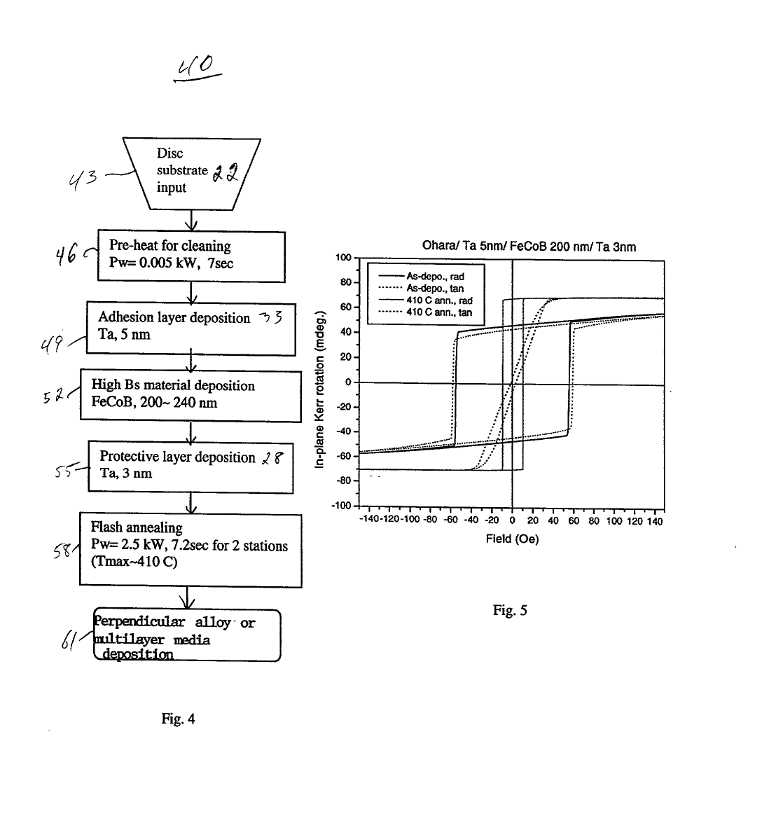

In order to manufacture the magnetic recording medium of the present invention the steps shown in the flow chart 40 of FIG. 4 are preferably followed. As shown in FIG. 4, the disc substrate 22 is provided 43. In order to prepare the disc substrate 22 for deposition of the layers, it is preferably preheated for cleaning 46 at a power level of about 0.005 kW for a period of about seven seconds. The tantalum adhesion layer 33 is then deposited 49 thereon to the thickness of between 1-5 nm, and most preferably at about 5 nm. The soft magnetic underlayer 19 is then deposited 52 thereon, such as by the sputtering technique, and has a total thickness between 150-300 nm, and most preferably of about 200-240 nm. A second tantalum layer of about 3 nm is provided thereon 55 so as to provide the protective interlayer 28 for the deposition of the actual perpendicular recording material 25 on the soft magnetic underlayer 19. A flash annealing process may be performed 58 prior to the deposition of the alloy recording media 25 to maximize the magnetic properties of this soft magnetic underlayer 19, which annealing process preferably is done at a temperature of 100-200° C. for a period of about seven seconds. This provides a power output of about 2.5 kW to the structure. At this point the recording alloy is deposited thereon 61 to provide the finished magnetic recording medium.

The inventors have also discovered a perpendicular magnetic recording material, provided by an exchange decoupled cobalt/noble metal perpendicular media by grading the cobalt alloy thickness, and is disclosed in co-pending application Ser. No. ______ filed on ______ and assigned to the present assignee. The specification of applicants' co-pending application is hereby incorporated by reference in its entirety herein.

As shown in FIG. 2B, the soft magnetic underlayer 19 is preferably provided as laminated structure 34. Preferably this laminated magnetic underlayer structure 3 is comprised of alternating layers of an 34a, 34b, 34c, iron-cobalt-boron alloy (Fe Co B) and tantalum layers 64a, 64b, 64c. Preferably the individual iron-cobalt-boron layers 34a, 34b, 34c are about 80 nm or less in thickness and the tantalum layers 64a, 64b, 64c are between 0-5 nm in thickness that is, at a tantalum layer of 0 nm in thickness, the iron-cobalt-boron layer is generally continuous. In the most preferred embodiment such alternating layers are deposited on the substrate to provide the laminated soft magnetic underlayer 34 for the perpendicular recording medium 10 herein. Alternatively, there may be a first iron-cobalt-boron layer of about 80 nm in thickness and a second such layer of about 160 nm in thickness, separated by a tantalum layer, so that the total SUL layer is about 240 nm thick.

In the most preferred embodiment, the iron-cobalt-born alloy comprises about 90% FeCo alloy and about 10% Boron. Most preferably the FeCo alloy comprises about 65% of Fe and 35% Co.

It has been discovered that the intermediate tantalum layers 64a, 64b, 64c providing a laminated structure eliminate the crystallization of the overall iron-cobalt-boron layers 34a, 34b, 34c during manufacture. Alternatively, interrupting the deposition process and allowing the structure to cool between layer depositions can also prevent crystallization. Preventing crystallization minimizes noise in the recording medium.

Prior to the deposition of the actual perpendicular recording material on the soft magnetic underlayer, preferably the interlayer 28 comprising a cobalt chromium alloy (Co Cr) can be deposited on the laminated structure 34 prior to the deposition of the actual perpendicular recording material.

As shown in FIG. 3, generally, the thinner magnetic thin film and the magnetic easy axis lies parallel to the film plane. When amorphous SUL 19 (FeCoB in this example) is deposited on a disc substrate 22, the SUL film has a tendency of exhibiting in-plane anisotropy as shown in this figure. In this case, FeCoB films thinner than 80 nm become highly anisotropic. Namely, there is no difference in remanent magnetization in the circumferential direction. This naturally leads to the laminated structure 34 as shown in FIG. 2B. As long as the 80 nm thick FeCoB layers 34a, 34b, 34c are deposited in discontinuous fashion, the entire laminated structure remains anisotropic, regardless of total FeCoB thickness. Once the anisotropic SUL stack is completed, the anisotropic nature is stable even after a heat treatment such as 200° C. at 15 sec annealing, which is typical pre-heating condition for a disc manufacturing process.

There is another option for inducing the in-plane anisotropy in FeCoB film. FIGS. 4 and 5 are used to explain this option. As shown in FIG. 3, the thick single-layer FeCoB (>150 nm) is isotropic in as-deposited state. By choosing proper post-annealing condition as shown in FIG. 4, the isotropic FeCoB becomes anisotropic. The two MOKE loops in FIG. 5 marked ‘As-depo, rad/tan’ represent the isotropic nature of the as-deposited film. The remanent magnetization (the Kerr rotation at zero field) in the as-deposited states as well as the overall hysteresis loop shape are more or less identical in the radial, and tangential direction. The other two loops taken after the flash annealing, on the other hand, are very different. The remanent Kerr rotation for ‘410C ann. rad’ is around 70 mdeg, whereas that of ‘410C ann. tan’ is around zero (anisotropic). Furthermore, the easy axis coercivity has dropped considerably as a result of the 410C annealing step. By comparison the coercivities of ‘As-depo’ loops and ‘410C ann.’ loops, the improvement in the magnetic softness is evident.

While specific embodiments of the invention have been described in detail, it will be appreciated by those skilled in the art that various modifications and alterations would be developed in light of the overall teachings of the disclosure. Accordingly, the particular arrangements disclosed are meant to be illustrative only and not limiting as to the scope of the invention which is to be given the full breadth of the appended claims and in any and all equivalents thereof.

What is claimed is:

1. A magnetic recording medium comprising:
a substrate;
a non-magnetic spacer material on the substrate; and
a soft magnetic underlayer on the non-magnetic spacer material, the soft magnetic underlayer containing iron, cobalt and boron.

2. The magnetic recording medium as recited in claim 1, wherein the non-magnetic spacer material is approximately 0-5 nm thick.

3. The magnetic recording medium as recited in claim 1, wherein the soft magnetic underlayer is approximately 240 nm thick.

4. The magnetic recording medium as recited in claim 3, wherein the soft magnetic underlayer is comprised of alternating layers of an iron-cobalt alloy and tantalum.

5. The magnetic recording medium as recited in claim 4, wherein the SUL comprises that iron-cobalt layers of about 80 nm thick and three tantalum layers of about 0-5 nm thick.

6. The magnetic recording medium as recited in claim 4, wherein the SUL comprises a first iron-cobalt layer of about 80 nm thick and a second iron-cobalt layer of about 160 nm thick having a tantalum layer of about 0-5 nm thick therebetween.

7. The magnetic recording medium as recited in claim 1, wherein the soft magnetic underlayer is further comprised of about 90 atomic percent iron-cobalt alloy and about 10 atomic percent of boron.

8. The magnetic recording medium as recited in claim 4, wherein the iron-cobalt alloy is further comprised of about 65 atomic percent iron and about 35 atomic percent cobalt.

9. The magnetic recording medium as recited in claim 1, further comprising a plurality of alternating non-magnetic spacer material and soft magnetic underlayers.

10. The magnetic recording medium as recited in claim 1, further comprising a second non-magnetic spacer material on the soft magnetic underlayer.

11. The magnetic recording medium as recited in claim 7, further comprising a perpendicular magnetic recording layer on the second non-magnetic spacer material.

12. The magnetic recording medium as recited in claim 6, further comprising a second non-magnetic spacer material on the soft magnetic underlayer.

13. The magnetic recording material as recited in claim 1, wherein the non-magnetic spacer material contains tantalum.

14. A method of manufacturing a perpendicular magnetic recording medium, the method comprising:
providing a substrate;
depositing a non-magnetic spacer material on the substrate;
depositing a soft magnetic underlayer containing iron, cobalt and boron on the non-magnetic spacer material; and
depositing a perpendicular magnetic recording material on the soft magnetic underlayer.

15. The method as recited in claim 11, wherein the step of depositing the soft magnetic underlayer comprises depositing a soft magnetic underlayer containing approximately 90 atomic percent iron-cobalt alloy and approximately 10 atomic percent boron.

16. The method as recited in claim 12, wherein the step of depositing the soft magnetic underlayer further comprises depositing a soft magnetic underlayer having a iron-cobalt alloy containing approximately 65 atomic percent iron and approximately 35 atomic percent cobalt.

17. The method as recited in claim 11, wherein the step of depositing the soft magnetic underlayer includes depositing the soft magnetic underlayer at a thickness of about 80 nm.

18. The method as recited in claim 13, wherein the step of depositing the soft magnetic underlayer includes depositing the soft magnetic underlayer at a thickness of about 80 nm.

19. The method as recited in claim 13, wherein the step of depositing the nonmagnetic spacer material comprises depositing a tantalum layer on the substrate.

20. The method as recited in claim 16, wherein the tantalum layer is deposited at a thickness of about 1-5 nm.

21. The method as recited in claim 14, wherein the step of depositing the nonmagnetic spacer material comprises depositing a tantalum layer on the substrate.

22. The method as recited in claim 18, wherein the tantalum layer is deposited at a thickness of about 1-5 nm.

23. The method as recited in claim 15, wherein the step of depositing the non-magnetic spacer material comprises depositing a tantalum layer on the substrate.

24. The method as recited in claim 20, wherein the tantalum layer is deposited at a thickness of about 1-5 nm.

25. The method as recited in claim 11, further comprising the step of depositing a second non-magnetic spacer material on the soft magnetic underlayer under the perpendicular recording medium.

26. A method of manufacturing a magnetic recording medium, the method comprising:
providing a substrate;
depositing a first non-magnetic spacer material on the substrate;
depositing a soft magnetic underlayer containing iron, cobalt and boron on the non-magnetic spacer material; and
depositing a second non-magnetic spacer material on the soft magnetic underlayer.

27. The method as recited in claim 23, further comprising the step of annealing the magnetic recording medium.

28. The method as recited in claim 24, further comprising the step of depositing a perpendicular recording medium on the second non-magnetic spacer material.
